(19) United States
(12) Patent Application Publication
(10) Pub. No.: US 2014/0201299 A1
(43) Pub. Date: Jul. 17, 2014

(54) INTER-PLATFORM INFORMATION SHARING SYSTEM AND METHOD, SERVER, COMPUTER STORAGE MEDIUM

(71) Applicant: TENCENT TECHNOLOGY (SHENZHEN) COMPANY LIMITED, Shenzhen (CN)

(72) Inventors: Zhu LIANG, Shenzhen (CN); Lingli KONG, Shenzhen (CN); Huabin XU, Shenzhen (CN); Lijin DENG, Shenzhen (CN); Zhihao ZHENG, Shenzhen (CN); Qingling YAN, Shenzhen (CN); Yuhuai GUI, Shenzhen (CN); Min CHEN, Shenzhen (CN); Tao CAO, Shenzhen (CN); Xiaojun HUANG, Shenzhen (CN); Baodong YANG, Shenzhen (CN); Jian ZHANG, Shenzhen (CN); Guihong BAI, Shenzhen (CN); Yang YU, Shenzhen (CN); Gang SHEN, Shenzhen (CN); Gui ZHANG, Shenzhen (CN)

(73) Assignee: TENCENT TECHNOLOGY (SHENZHEN) COMPANY LIMITED, Shenzhen (CN)

(21) Appl. No.: 14/217,732

(22) Filed: Mar. 18, 2014

Related U.S. Application Data
(63) Continuation of application No. PCT/CN2012/078312, filed on Jul. 6, 2012.

(30) Foreign Application Priority Data
Sep. 16, 2011 (CN) 201110276315.5

(51) Int. Cl. H04L 12/58

(52) U.S. Cl. CPC H04L 51/32
USPC 709/206

(57) ABSTRACT

Disclosed is an inter-platform information sharing system, including an interface module, a control module and a database, wherein the interface module is configured to receive information obtained through a first platform and acquire the information from the database and synchronize the acquired information with the counterpart on a second platform, or receive information obtained through the second platform and acquire the information from the database and synchronize the acquired information with the counterpart on the first platform, and the control module is configured to control the interface module to receive the information and acquire the information from the database, and control the database to store the obtained information. In addition, an inter-platform information sharing method, a server and a computer storage medium are also provided.

### TECHNICAL FIELD

The present invention relates to the field of information sharing, in particularly, to an inter-platform information sharing system and method, a server and a computer storage medium.

### TECHNICAL BACKGROUND

Online platforms, such as a microblog platform, a Social Networking Services (SNS) community and an online community, offer different service contents to meet user's needs.

Among others, the microblog refers to such a type of micro-blog that can be timely updated and publicly posted by a user and be allowed for reading by anyone or by a specified group. The microblog may be transferred in various manners, specifically including a short message, an instant messaging software, an e-mail and a web page. Therefore, the user can build a personal community on the microblog platform by means of Web, WAP and various client software/applications, to post and update information, thereby sharing information in real time.

The SNS community is an online service platform, on which an online community may be built for a group of people with the same interests and activities. The social networking services are typically based on the Internet and aim to provide users with various interactive channels for contacting and exchanging, such as an e-mail service and an instant messaging service which may serve for chatting, sending mails, video and file sharing, blog, discussion groups, and so on. There are currently many SNS communities such as Facebook, Myspace, Twitter, Renren and Kaixin around the world.

The online community is a virtual community over the Internet, of which members aggregate together based on some common purpose. Anyone is allowed to post contents within the online community, for example, to post text contents in a chat room, or to post an audio, a video, text and so on in a forum.

However, information on each platform can be presented on this platform merely and cannot be shared to other platforms, which is disadvantageous for information exchanging between different platforms, thus reducing the utilization of network resources.

### SUMMARY OF THE INVENTION

In view of the above, there is a need to provide an inter-platform information sharing system for improving the utilization of network resources.

An inter-platform information sharing system includes an interface module, a control module and a database. The interface module is configured to receive information obtained through a first platform and acquire the information from the database and synchronize the acquired information with the counterpart on a second platform, or receive information obtained through the second platform and acquire the information from the database and synchronize the acquired information with the counterpart on the first platform, and the control module is configured to control the interface module to receive the obtained information and the acquired information, and control the database to store the obtained information.

In addition, there is a need to provide an inter-platform information sharing method for improving the utilization of network resources.

An inter-platform information sharing method includes the following steps of:
receiving information obtained through a first platform or a second platform;
storing the information in the database; and
acquiring, from the database, the information obtained through the first platform and synchronizing the acquired information with the counterpart on the second platform; or acquiring, from the database, the information obtained through the second platform and synchronizing the acquired information with the counterpart on the first platform.

In addition, there is also a need to provide a server for improving the utilization of network resources.

A server includes an interface module, a control module and a database. The interface module is configured to receive information obtained through a first platform, acquire the information from the database and synchronize the acquired information with the counterpart on a second platform; or receive information obtained through the second platform, acquire the information from the database and synchronize the acquired information with the counterpart on the first platform, and the control module is configured to control the interface module to receive the obtained information and the acquired information, and control the database to store the obtained information.

In addition, there is also a need to provide a computer storage medium for improving the utilization of network resources.

One or more computer storage media include computer-executable instructions used to perform an inter-platform information sharing method, and the method includes the following steps of:
receiving information obtained through a first platform or a second platform;
storing the information in a database; and
acquiring, from the database, the information obtained through the first platform and synchronizing the acquired information with the counterpart on the second platform; or acquiring, from the database, the information obtained through the second platform and synchronizing the acquired information with the counterpart on the first platform.

With the inter-platform information sharing system and method, the server, and the computer storage medium mentioned above, information obtained through the first platform is obtained and synchronized with the counterpart on the second platform, or information obtained through the second platform is received and synchronized with the counterpart on the first platform, thus implementing the information sharing between these two platforms, implementing network resource sharing, and improving the utilization of network resources. Further, the cost is reduced since the database is shared among a plurality of platforms.

### DESCRIPTION OF DRAWINGS

FIG. 1 is a schematic diagram showing the structure of an inter-platform information sharing system according to an embodiment;

FIG. 2 is a schematic diagram showing the structure of an information sharing system between a microblog platform and a social networking platform;

FIG. 3 is a schematic diagram showing the internal structure of a server according to an embodiment;

FIG. 4 is a flowchart of an inter-platform information sharing method according to an embodiment;

FIG. 5 is a specific flowchart of information sharing between a microblog platform and a social networking platform; and

FIG. 6 is a specific flowchart of the information sharing between a microblog platform and a social networking platform that is applied to the vote sharing.

### DETAILED DESCRIPTION OF THE PREFERRED EMBODIMENT

The inter-platform information sharing system and method, a server and a computer storage medium are described in detail with reference to specific embodiments and the accompanying drawings.

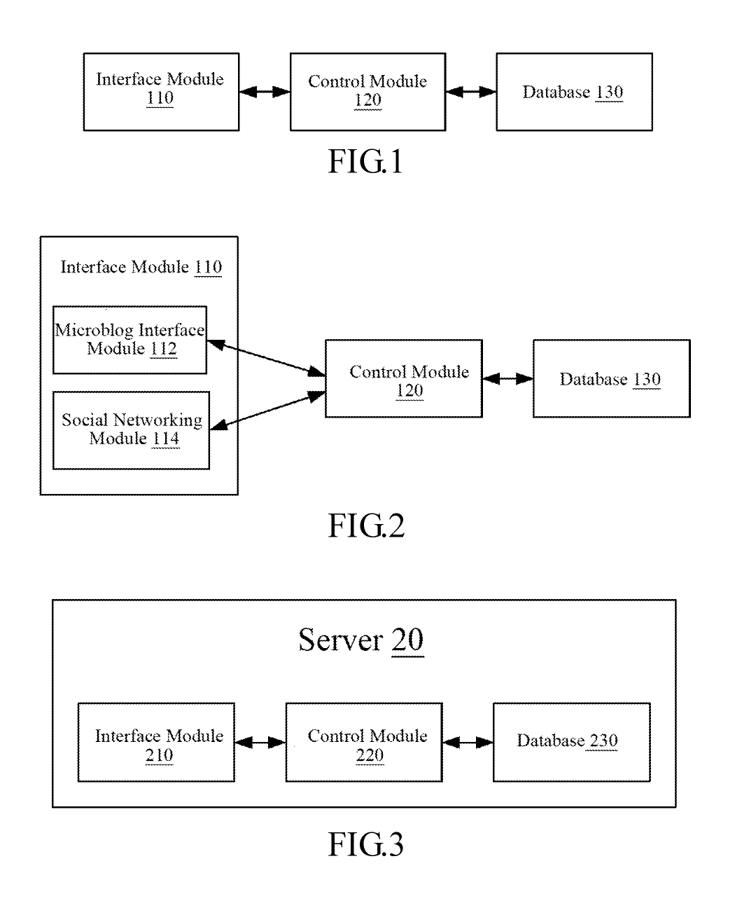

In an embodiment, as shown in FIG. 1, an inter-platform information sharing system includes an interface module 110, a control module 120 and a database 130.

The interface module 110 is configured to receive information obtained through a first platform or a second platform. Information can be inputted by a user through a plurality of platforms, which may include a microblog platform, a social networking platform, and the like. The social networking platform may include, but is not limited to, the Renren platform, the Myspace platform, the Alumni platform, Facebook, etc. In the embodiment, the information sharing between two platforms is described, but the information sharing is not limited between two platforms. The interface module 110 may be provided with different interfaces for different platforms, such as a microblog interface module and a social networking interface module. In addition, a mobile phone interface module may be provided in order to facilitate the access to the platform by a mobile phone user.

The control module 120 is configured to control the interface module 110 to receive the information and acquire information from the database 130, and to control the database 130 to store the received information. The control module 120 pertains to the logical layer, and is preliminarily used for logic processing on a service (e.g., information storing). The information received by the interface module 110 may be one or both of the information obtained through the first platform and the information obtained through the second platform.

The database 130 is a User Generated Content (UGC) database, which is more suitable for reading and writing a large amount of information than a Memory Cache database.

The interface module 110 is also configured to acquire the information from the database 130 and then synchronize the acquired information with the counterpart on the second platform or the first platform. That is, the interface module 110 acquires from the database 130 the information obtained through the first platform and synchronizes the acquired information with the counterpart on the second platform, and acquires from the database 130 the information obtained through the second platform and synchronizes the acquired information with the counterpart on the first platform, thereby achieving synchronous sharing of the information between the first and second platforms. The interface module 110 may acquire the information from the database 130 by means of information reading or downloading.

In addition, the information inputted by the user through various platforms is stored in the database 130 in the order of input time of the information, in order to be acquired and then presented by the platforms as per service requirements of the platforms.

After the information presented on the first platform is deleted, the counterpart of the information that is stored in the database 130 is also deleted, and the information cannot be presented on the second platform anymore.

In an embodiment, the first platform is a microblog platform and the second platform is a social networking platform, for example, and the process of sharing information between the microblog platform and the social networking platform is illustrated below. As shown in FIG. 2, the interface module 110 includes a first interface module and a second interface module, where the first interface module is the microblog interface module 112 and the second interface module is the social networking interface module 114.

The microblog interface module 112 receives microblog information obtained through the microblog platform, and stores the microblog information in the database 130. A user is allowed to input the microblog information through the microblog platform, for example, the user inputs the microblog information of “The weather is nice today!”, and the microblog information is stored in the database 130. The microblog information obtained through the microblog platform may be microblog information inputted by the user via a microblog platform installed on the User Equipment.

The social networking interface module 114 acquires the microblog information from the database 130 under the control of the control module 120, and synchronizes the acquired microblog information with the counterpart on the social networking platform. The acquired microblog information is synchronously presented on the social networking platform in accordance with presentation requirements of the social networking platform. The social networking interface module 114 acquires one of information from the database based on the order of obtainment time of the information, and compares the acquired information and its obtainment time with the already presented information and its obtainment time on the social networking platform; if the acquired information and its obtainment time are the same with the presented information and its obtainment time already on the social networking platform, then the acquired information and its obtainment time will not be presented on the social networking platform, otherwise, if the acquired information and its obtainment time are different from the presented information and its obtainment time already on the social networking platform, then the acquired information and its obtainment time are presented on the social networking platform, that is, the social networking platform is synchronized to contain the acquired information and its obtainment time. The acquiring one of information from the database based on the order of obtainment time of the information refers to reading or downloading one of information to the cache. Then, the read or downloaded information and its obtainment time are compared with the already present information and its obtainment time on the social networking platform. The obtainment time refers to the time when the information is acquired by the platform.

Meanwhile, the social networking interface module 114 is also configured to receive community information obtained through the social networking platform, and store the community information in the database 130. A user is allowed to input the community information, such as a log message of “floral language”, through the social networking platform. The community information is diversified and includes dynamic information, log information, album updating information, posting information, and so on, of friends.

The microblog interface module 112 is also configured to acquire the community information from the database 130 under the control of the control module 120, and synchronize the acquired community information with the counterpart on the microblog platform. The acquired community information is presented in accordance with presentation requirements of the microblog platform. The microblog interface module 112 acquires one of information from the database 130 based on the order of obtainment time of the information, and compares the acquired information and its obtainment time with the already presented information and its obtainment time on the microblog platform; if the acquired information and its obtainment time are the same with the already presented information and its obtainment time on the microblog platform, then the acquired information and its obtainment time will not be presented on the microblog platform, otherwise, if the acquired information and its obtainment time are different from the already presented information and its obtainment time on the microblog platform, then the acquired information and its obtainment time are presented on the microblog platform, that is, the microblog platform is synchronized to contain the acquired information and its obtainment time.

The information sharing between the microblog platform and the social networking platform is further described below by an example of sharing voting information between the two platforms.

The microblog interface module 112 receives a voting request and the vote content initiated by the user through the microblog platform, which are stored in the database 130. The voting is a tool used by a user to obtain a conclusion based on his/her voting right on the Internet. For a voting request as to “whether to go out if it rains tomorrow”, for example, the vote content may include: “Don't go out if it rains”, “Go out regardless of the weather”, “Do not matter”, and so on.

When the voting request is received by the microblog interface module 112, a voting identifier may be assigned by the database 130 to identity the different voting request. The database 130 is also configured to store the voting identifier and the corresponding voting request as well as the vote content.

In addition, the microblog interface module 112 can also receive a participant voting content obtained by the user through the microblog platform and the obtainment time of the participant voting content, and store the participant voting content and its obtainment time in the database 130.

The microblog interface module 112 acquires the vote content from the database 130 based on the order of obtainment time of the vote content, and compares the acquired vote content and its obtainment time with the already presented vote content and its obtainment time on the microblog platform; if the acquired vote content and its obtainment time are the same with the already presented vote content and its obtainment time on the microblog platform, then the acquired vote content and its obtainment time will not be presented on the microblog platform by the microblog interface module 112, otherwise, if the acquired vote content and its obtainment time are different from the already presented vote content and its obtainment time on the microblog platform, then the acquired vote content and its obtainment time are presented on the microblog platform by the microblog interface module 112, that is, the microblog platform is synchronized to contain the acquired vote content and its obtainment time.

The social networking interface module 114 acquires the vote content from the database 130 under the control of the control module 120, and synchronizes the acquired vote content with the counterpart on the social networking platform. The social networking interface module 114 is also configured to receive the participant voting content obtained through the social networking platform and store the participant voting content in the database 130. The social networking interface module 114 can acquire the participant voting content from the database 130 based on the order of obtainment time of the participant voting content, and compare the acquired participant voting content and its obtainment time with the already presented participant voting content and its obtainment time on the social networking platform; if the acquired participant voting content and its obtainment time are the same with the already presented participant voting content and its obtainment time on the social networking platform, then the acquired participant voting content and its obtainment time will not be presented on the social networking platform, otherwise, if the acquired participant voting content and its obtainment time are different from the already presented participant voting content and its obtainment time on the social networking platform, then the acquired participant voting content and its obtainment time are presented on the social networking platform together.

The microblog interface module 112 acquires the participant voting content from the database 130 under the control of the control module 120, and synchronizes the acquired participant voting content with the counterpart on the microblog platform, thereby ensuring that the vote content and the participant voting content are synchronized and updated in real time between the microblog platform and the social networking platform.

If the vote content on the microblog platform is deleted by the user, the counterpart of the vote content in the database 130 is also deleted, and the vote content cannot be presented on the social networking platform.

If both users on the microblog platform and on the social networking platform take a vote on the vote content, then the obtained participant voting content and its obtainment time are stored in the database 130 based on the order of the obtainment time.

In addition, the voting request and the vote content may also be initiated by the user through the social networking platform, and then the vote content is synchronized with the counterpart on the microblog platform.

In an embodiment, as shown in FIG. 3, a server 20 includes an interface module 210, a control module 220, and a database 230. The interface module 210 is configured to receive information obtained by a user through a first platform, and acquire the information from the database 230 and synchronize the acquired information with the counterpart on the second platform; or the interface module 210 is configured to receive information obtained through the second platform, and acquire the information from the database 230 and synchronize the acquired information with the counterpart on the first platform. The control module 220 is configured to control the interface module 210 to receive and acquire the information, and control the database 230 to store the received information. The interface module 210, the control module 220 and the database 230 have the same functions as the interface module 110, the control module 120 and the database 130 in the above inter-platform information sharing system, respectively, thus will not be described again hereinafter.

In addition, the interface module 210 also includes a first interface module and a second interface module. The first interface module and the second interface module respectively may be the microblog interface module and the social networking interface module, which have the same functions as the microblog interface module 112 and the social networking interface module 114 contained in the interface module 110 in the above inter-platform information sharing system, respectively, thus will not be described again hereinafter.

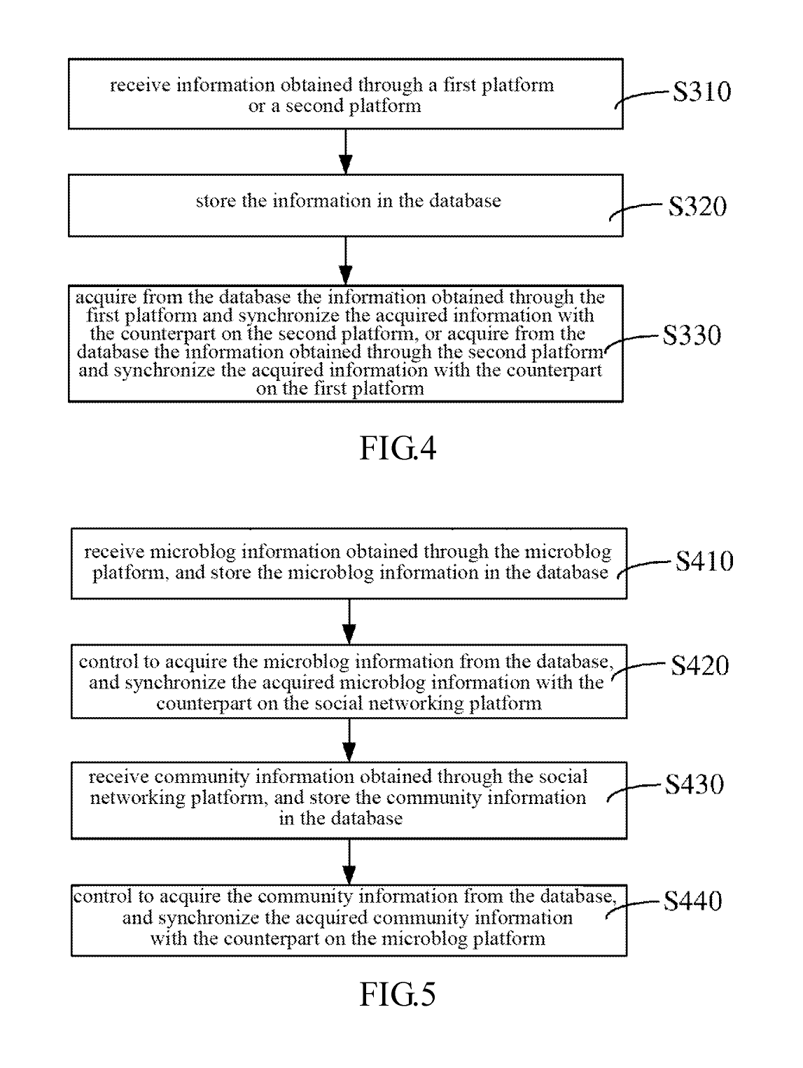

In an embodiment, as shown in FIG. 4, an inter-platform information sharing method includes the following steps S310-S330.

At the step S310, information obtained through a first platform or a second platform is received.

Information may be input by a user through various platforms, which may include a microblog platform, a social networking platform, and the like. The social networking platform may include, but is not limited to, the Renren platform, the Myspace platform, the Alumni platform, Facebook, etc. The information sharing between two platforms is described, but the information sharing is not limited between two platforms. The information inputted by the user is received through the interface module 110. The interface module 110 may be provided with different interface for different platforms, such as a microblog interface module and a social networking interface module. In addition, a mobile phone interface module may be provided in order to facilitate the access to the platform by a mobile phone user.

At the step S320, the information is stored in the database.

A database 130, which may be a UGC database, is used to store the information. The UGC database is more suitable for reading and writing a large amount of information.

At the step S330, the information obtained through the first platform is acquired from the database 130 and synchronized with the counterpart on the second platform, or the information obtained through the second platform is acquired from the database 130 and synchronized with the counterpart on the first platform.

The information obtained through the first platform is acquired from the database 130 and synchronized with the counterpart on the second platform, and the information obtained through the second platform is acquired from the database 130 and synchronized with the counterpart on the first platform, thereby achieving the synchronous sharing of the information between the first and second platforms.

The information inputted by the user through the various platforms is stored based on the order of time when the platforms obtain the information, and may be obtained and then presented by the platforms according to service requirements of the platforms.

In an embodiment, as shown in FIG. 5, the first platform is the microblog platform, the second platform is the social networking platform, and the information sharing between these two platforms specifically includes the following steps S410-S440.

At the step S410, microblog information obtained through the microblog platform is received, and stored in the database.

The user is allowed to input the microblog information, such as the microblog information of “It rains today”, through the microblog platform, and the micro-blog information is stored in the database.

At the step S420, it is controlled to acquire the microblog information from the database and synchronize the acquired microblog information with the counterpart on the social networking platform.

The acquired microblog information is synchronously presented on the social networking platform in accordance with presentation requirements of the social networking platform. Specifically, one of information is acquired from the database based on the order of obtainment time of the information, and the acquired information and its obtainment time are compared with the already presented information and its obtainment time on the social networking platform; if the acquired information and its obtainment time are the same with the already presented information and its obtainment time on the social networking platform, then the acquired information and its obtainment time will not be presented on the social networking platform, otherwise, if the acquired information and its obtainment time are different from the already presented information and its obtainment time on the social networking platform, then the acquired information and its obtainment time are presented on the social networking platform, that is, the social networking platform is synchronized to contain the acquired information and its obtainment time.

At the step S430, community information obtained through the social networking platform is received and stored in the database.

The user inputs the community information through the social networking platform. The community information is diversified and includes dynamic information, log information (for example, log information of “there is a garden behind the house”), album updating information, posting information, and so on, of social members.

At the step S440, it is controlled to acquire the community information from the database and synchronize the acquired community information with the counterpart on the microblog platform.

The acquired community information is presented in accordance with presentation requirements of the microblog platform. Specifically, one of information is acquired from the database based on the order of obtainment time of the information, and the acquired information and its obtainment time are compared with the already presented information and its obtainment time on the microblog platform; if the acquired information and its obtainment time are the same with the already presented information and its obtainment time on the microblog platform, then the acquired information and its obtainment time will not be presented on the microblog platform, otherwise, if the acquired information and its obtainment time are different from the already presented information and its obtainment time on the microblog platform, then the acquired information and its obtainment time are presented on the microblog platform, that is, the microblog platform is synchronized to contain the acquired information and its obtainment time.

Further, the order of the steps S410 and S430 as listed above is for illustration and is not limited, and the invention is not limited thereto.

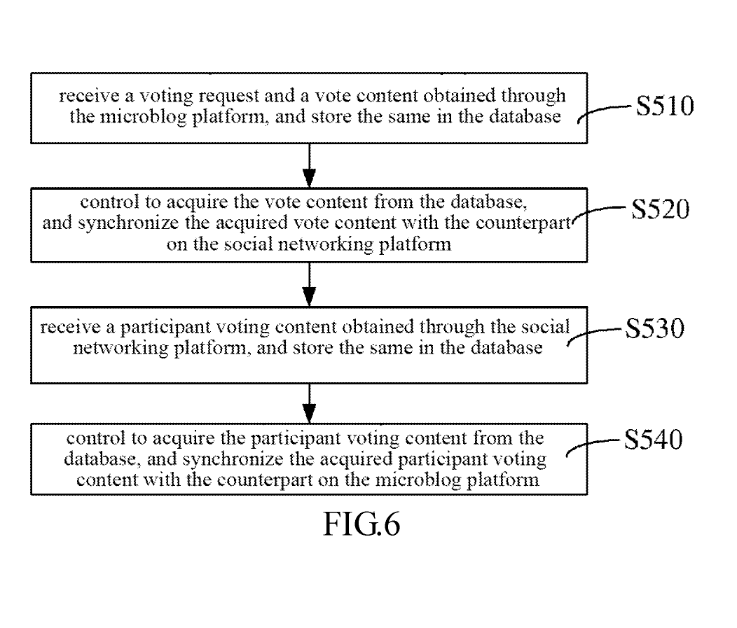

In an embodiment, as shown in FIG. 6, the vote sharing between the microblog platform and the social networking platform specifically includes the following steps S510-S540.

At the step S510, a voting request and a vote content obtained through the microblog platform are received and stored in the database.

The microblog interface module 112 receives the voting request and the vote content initiated by the user through the microblog platform, which are then stored in the database 130. For example, for a voting request with regard to “driving restriction during the Olympic Games”, the vote content may include “Agree”, “Disagree”, “Do not matter”, and so on.

When the voting request inputted by the user is received, a voting identifier may be assigned to identify the voting request, and the voting identifier and the corresponding voting request as well as the vote content are stored.

In addition, a participant voting content obtained through the microblog platform may also be received and stored in the database. Both the participant voting content and its obtainment time are stored in the database.

At the step S520, it is controlled to acquire the vote content from the database and synchronize acquired vote content with the counterpart on the social networking platform.

The control module 120 controls the social networking interface module 114 to acquire the vote content from the database 130 and then synchronize the acquired vote content with the counterpart on the social networking platform. The vote content is acquired from the database based on the order of obtainment time of the vote content, and the acquired vote content and its obtainment time are compared with the already presented vote content and its obtainment time on the social networking platform; if the acquired vote content and its obtainment time are the same with the already presented vote content and its obtainment time on the social networking platform, then the acquired vote content and its obtainment time will not be presented on the social networking platform, otherwise, if the acquired vote content and its obtainment time are different from the already presented vote content and its obtainment time on the social networking platform, then the acquired vote content and its obtainment time are presented on the social networking platform, that is, the social networking platform is synchronized to contain the acquired vote content and its obtainment time.

At the step S530, the participant voting content obtained through the social networking platform is received and stored in the database.

The user is allowed to take a vote through the social networking platform by inputting the participant voting content. After that, the participant voting content and its obtainment time are stored in the database. The obtainment time refers to the time when the participant voting content is obtained by the social networking platform.

At the step S540, it is controlled to acquire the participant voting content from the database and synchronize the acquired participant voting content with the counterpart on the microblog platform.

The control module 120 controls the microblog interface module 112 to acquire the participant voting content from the database 130 and synchronize the acquired participant voting content with the counterpart on the microblog platform. The participant voting content is acquired from the database based on the order of obtainment time of the participant voting content, and the acquired participant voting content and its obtainment time are compared with the already presented participant voting content and its obtainment time on the microblog platform; if the acquired participant voting content and its obtainment time are the same with the already presented participant voting content and its obtainment time on the microblog platform, then the acquired participant voting content and its obtainment time will not be presented on the microblog platform, otherwise, if the acquired participant voting content and its obtainment time are different from the already presented participant voting content and its obtainment time on the microblog platform, then the acquired participant voting content and its obtainment time are presented on the microblog platform together.

On the microblog platform and the social networking platform, the participant voting content inputted by the user is presented in accordance with the order of obtainment time of the participant voting content, and the participant voting content and its obtainment time are acquired from the database content in real time for comparison. Any participant voting content and its obtainment time which have not been presented on the microblog platform or the social networking platform are updated to the microblog platform or the social networking platform in time, so that the vote taken by the user via either microblog platform or the social networking platform can be presented synchronously on both platforms, thereby ensuring that the vote content and the participant voting content are synchronized and updated in real time between the microblog platform and the social networking platform.

Further, the order of the steps S510 and S530 as listed above is for illustration and is not limited, and the invention is not limited thereto.

Further, the invention further provides one or more computer storage media including computer-executable instructions, which are used to perform an inter-platform information sharing method. The specific steps of the inter-platform information sharing method performed by the computer-executable instructions in the computer storage media are the same as those in the above method, and are not described hereinafter.

With the inter-platform information sharing system and method, the server, and the computer storage medium mentioned above, information obtained through the first platform is obtained and synchronized with the counterpart on the second platform, or information obtained through the second platform is received and synchronized with the counterpart on the first platform, thus implementing the information sharing between these two platforms, implementing network resource sharing, and improving the utilization of network resources. Further, the cost is reduced since the database is shared among a plurality of platforms.

In addition, the information sharing between the microblog platform and social networking platform facilitates the exchange of information between the platforms, the information propagation and interaction between the users, and user operations, and further improves the effects of user experience. The sharing of the vote content facilitates the participation of the users in different platforms, user interactions, and collection of the participant voting contents of the users, and further improves the utilization of network resources without posting the vote contents in different platforms.

The above embodiments are described merely for illustrating the implementations of the present invention, but shall not be interpreted as the limitation on the scope of present invention despite of the relatively specific and detailed description of the embodiments. It is noted that those skilled in the art can make variations and modifications without departing from the inventive concept of the present invention, and all the variations and modifications fall within the scope of the present invention. Accordingly, the scope of the present invention is defined by the attached claims.

1. An inter-platform information sharing system, comprising an interface module, a control module and a database, wherein the interface module is configured to receive information obtained through a first platform and acquire the information from the database and synchronize the acquired information with the counterpart on a second platform, or receive information obtained through the second platform and acquire the information from the database and synchronize the acquired information with the counterpart on the first platform, and the control module is configured to control the interface module to receive the information and acquire the information from the database, and control the database to store the information received by the interface module.

2. The system of claim 1, wherein the first platform is a microblog platform, the second platform is a social networking platform, the interface module includes a first interface module and a second interface module, the first interface module is a microblog interface module and the second interface module is a social networking interface module, the microblog interface module is configured to receive microblog information obtained through the microblog platform and store the microblog information in the database, and the social networking interface module is configured to acquire the microblog information from the database under the control of the control module and synchronize the acquired microblog information with the counterpart on the social networking platform.

3. The system of claim 2, wherein the social networking interface module is further configured to receive community information obtained through the social networking platform and store the community information in the database, and the microblog interface module is further configured to acquire the community information from the database under the control of the control module, and synchronize the acquired community information with the counterpart on the microblog platform.

4. The system of claim 3, wherein the microblog interface module is further configured to compare the community information and its obtainment time acquired from the database with the already presented information and its obtainment time on the microblog platform; and if the community information and its obtainment time acquired from the database are different from the already presented information and its obtainment time on the microblog platform, then the acquired community information and its obtainment time are presented on the microblog platform.

5. The system of claim 2, wherein the social networking interface module is further configured to compare the microblog information and its obtainment time acquired from the database with the already presented information and its obtainment time on the social networking platform; and if the microblog information and its obtainment time acquired from the database are different from the already presented information and its obtainment time on the social networking platform, then the acquired microblog information and its obtainment time are presented on the social networking platform.

6. The system of claim 1, wherein the first platform is a microblog platform, the second platform is a social networking platform, the interface module includes a first interface module and a second interface module, the first interface module is a microblog interface module and the second interface module is a social networking interface module, the microblog interface module is configured to receive a voting request and a vote content obtained through the microblog platform and store the same in the database, the social networking interface module is configured to acquire the vote content from the database under the control of the control module and synchronize the acquired vote content with the counterpart on the social networking platform, and receive a participant voting content obtained through the social networking platform and store the participant voting content in the database, and the microblog interface module is configured to acquire the participant voting content from the database under the control of the control module and synchronize the acquired participant voting content with the counterpart on the microblog platform.

7. The system of claim 6, wherein the social networking interface module is further configured to acquire the participant voting content from the database based on the order of obtainment time of the participant voting content, and compare the acquired participant voting content and its obtainment time with the already presented participant voting content and its obtainment time on the social networking platform; if the participant voting content and its obtainment time acquired from the database are different from the already presented participant voting content and its obtainment time on the social networking platform, then the acquired participant voting content and its obtainment time are presented on the social networking platform together.

8. The system of claim 6, wherein the microblog interface module is further configured to acquire the participant voting content from the database based on the order of obtainment time of the participant voting content, and compare the acquired participant voting content and its obtainment time with the already presented participant voting content and its obtainment time on the microblog platform; if the participant voting content and its obtainment time acquired from the database are different from the already presented participant voting content and its obtainment time on the microblog platform, then the acquired participant voting content and its obtainment time are presented on the microblog platform together.

9. An inter-platform information sharing method, comprising steps of:
receiving information obtained through a first platform or a second platform;
storing the information in a database; and
acquiring, from the database, the information obtained through the first platform and synchronizing the acquired information with the counterpart on the second platform; or acquiring, from the database, the information obtained through the second platform and synchronizing the acquired information with the counterpart on the first platform.

10. The method of claim 9, wherein, the first platform is a microblog platform, the second platform is a social networking platform, information sharing between the microblog platform and the social networking platform specifically includes steps of:
receiving microblog information obtained through the microblog platform, and storing the microblog information in the database; and
controlling to acquire the microblog information from the database, and synchronize the acquired microblog information with the counterpart on the social networking platform;
and/or
receiving community information obtained through the social networking platform, and storing the community information in the database; and
controlling to acquire the community information from the database, and synchronize the acquired community information with the counterpart on the microblog platform.

11. The method of claim 10, wherein the controlling to acquire the community information from the database and synchronize the acquired community information with the counterpart on the microblog platform specifically includes:
comparing the community information and its obtainment time acquired from the database with the already presented information and its obtainment time on the microblog platform; if the community information and its obtainment time acquired from the database are different from the already presented information and its obtainment time on the microblog platform, then the acquired community information and its obtainment time are presented on the microblog platform.

12. The method of claim 10, wherein the controlling to acquire the microblog information from the database and synchronize the acquired microblog information with the counterpart on the social networking platform specifically includes:
comparing the microblog information and its obtainment time acquired from the database with the already presented information and its obtainment time on the social networking platform; if the microblog information and its obtainment time acquired from the database are different from the already presented information and its obtainment time on the social networking platform, then the acquired microblog information and its obtainment time are presented on the social networking platform.

13. The method of claim 9, wherein the first platform is a microblog platform, the second platform is a social networking platform, information sharing between the microblog platform and the social networking platform specifically includes steps of:
receiving a voting request and a vote content obtained through the microblog platform, and storing the voting request and the vote content in the database;
controlling to acquire the vote content from the database, and synchronize the acquired vote content with the counterpart on the social networking platform;
receiving a participant voting content obtained through the social networking platform, and storing the participant voting content in the database; and
controlling to acquire the participant voting content from the database, and synchronize the acquired participant voting content with the counterpart on the microblog platform.

14. The method of claim 13, wherein
the controlling to acquire the vote content from the database and synchronize the acquired vote content with the counterpart on the social networking platform specifically includes:
acquiring, from the database, the vote content based on the order of obtainment time of the vote content, comparing the acquired vote content and its obtainment time with the already presented vote content and its obtainment time on the social networking platform; if the acquired vote content and its obtainment time are different from the already presented vote content and its obtainment time on the social networking platform, then the acquired vote content and its obtainment time are presented on the social networking platform together;
and/or
wherein the controlling to acquire the participant voting content from the database and synchronize the acquired participant voting content with the counterpart on the microblog platform specifically includes:
acquiring, from the database, the participant voting content based on the order of obtainment time of the participant voting content, and comparing the acquired participant voting content and its obtainment time with the already presented participant voting content and its obtainment time on the microblog platform; if the acquired participant voting content and its obtainment time are different from the already presented participant voting content and its obtainment time on the microblog platform, then the acquired participant voting content and its obtainment time are presented on the microblog platform together.

15. The method of claim 9, wherein the storing the information in the database specifically includes: storing the information in a User Generated Content (UGC) database.

16. A server, comprising an interface module, a control module and a database, wherein the interface module is configured to receive information obtained through a first platform, acquire the information from the database and synchronize the acquired information with the counterpart on a second platform; or receive information obtained through the second platform, acquire the information from the database and synchronize the acquired information with the counterpart on the first platform, and the control module is configured to control the interface module to receive the information and acquire the information from the database, and control the database to store the received information.

17. The server of claim 16, wherein the first platform is a microblog platform, the second platform is a social networking platform, the interface module includes a first interface module and a second interface module, the first interface module is a microblog interface module and the second interface module is a social networking interface module,
the microblog interface module is configured to receive microblog information obtained through the microblog platform and store the microblog information in the database, and the social networking interface module is configured to acquire the microblog information from the database under the control of the control module and synchronize the acquired microblog information with the counterpart on the social networking platform;
and/or
the social networking interface module is configured to receive community information obtained through the social networking platform and store the community information in the database, and the microblog interface module is configured to acquire the community information from the database under the control of the control module, and synchronize the acquired community information with the counterpart on the microblog platform.

18. The server of claim 17, wherein the microblog interface module is further configured to compare the community information and its obtainment time acquired from the database with the already presented information and its obtainment time on the microblog platform; and if the community information and its obtainment time acquired from the database are different from the already presented information and its obtainment time on the microblog platform, then the acquired community information and its obtainment time are presented on the microblog platform; the social networking interface module is further configured to compare the microblog information and its obtainment time acquired from the database with the already presented information and its obtainment time on the social networking platform; and if the microblog information and its obtainment time acquired from the database are different from the already presented information and its obtainment time on the social networking platform, then the acquired microblog information and its obtainment time are presented on the social networking platform.

19. The server of claim 16, wherein the first platform is a microblog platform, the second platform is a social networking platform, the interface module includes a first interface module and a second interface module, the first interface module is a microblog interface module and the second interface module is a social networking interface module,
the microblog interface module is configured to receive a voting request and a vote content obtained through the microblog platform and store the same in the database, the social networking interface module is configured to acquire the vote content from the database under the control of the control module and synchronize the acquired vote content with the counterpart on the social networking platform, and receive a participant voting content obtained through the social networking platform and store the participant voting content in the database, and the microblog interface module is configured to acquire the participant voting content from the database under the control of the control module and synchronize the acquired vote content with the counterpart on the microblog platform;
and/or
the social networking interface module is configured to acquire the participant voting content from the database based on the order of obtainment time of the vote content, and compare the acquired participant voting content and its obtainment time with the already presented participant voting content and its obtainment time on the social networking platform;
if the vote content and its obtainment time acquired from the database are different from the already presented participant voting content and its obtainment time on the social networking platform, then the acquired participant voting content and its obtainment time are presented on the social networking platform together; the microblog interface module is configured to acquire the participant voting content from the database based on the order of obtainment time of the participant voting content, and compare the acquired participant voting content and its obtainment time with the already presented participant voting content and its obtainment time on the microblog platform; if the participant voting content and its obtainment time acquired from the database are different from the already presented participant voting content and its obtainment time on the microblog platform, then the acquired participant voting content and its obtainment time are presented on the microblog platform together.

20. A computer storage medium including computer-executable instructions used to perform an inter-platform information sharing method, wherein the method including steps of:
receiving information obtained through a first platform or a second platform;
storing the information in a database;
acquiring, from the database, the information obtained through the first platform and synchronizing the acquired information with the counterpart on the second platform; or acquiring, from the database, the information obtained through the second platform and synchronizing the acquired information with the counterpart on the first platform.
